(19) United States
(12) Patent Application Publication
(10) Pub. No.: US 2021/0191705 A1
(43) Pub. Date: Jun. 24, 2021

(54) Installing Multiple Patches During Upgrades

(71) Applicant: EMC IP Holding Company LLC, Hopkinton, MA (US)

(72) Inventors: Jared O'Dell, Tacoma, WA (US); Gene W. Lee, Seattle, WA (US); Zachary Jordan Reeves, Renton, WA (US)

(21) Appl. No.: 16/718,381

(22) Filed: Dec. 18, 2019

(51) Int. Cl. G06F 8/61; G06F 8/658; G06F 9/48; G06F 9/38

(52) U.S. Cl. CPC G06F 8/63; G06F 9/3891; G06F 9/485; G06F 8/658

(57) ABSTRACT

Techniques are provided for installing multiple patches during upgrades. In an example, an administrator specifies an upgrade image and multiple patches for a computing cluster. The computing cluster verifies compatibility between the upgrade image and the patch, registers the patch, and stores the patch for later use at the cluster level. This compatibility check can include a check that multiple patches do not write to the same file. Then, at the node level, the upgrade image and the patch are applied to each node that is upgraded.

### TECHNICAL FIELD

The present application relates generally to upgrading nodes of a computing cluster, e.g., to installing multiple patches during upgrades.

### BACKGROUND

In some examples, a computing cluster can comprise a plurality of computers, referred to as “nodes” or “computing nodes,” that can work in concert such that they can be viewed as a single system—the computing cluster. In some examples, a computing cluster can be utilized to implement a distributed file system that organizes a plurality of file shares that are distributed across multiple computing nodes of a computer system. A distributed file system can offer a single namespace across the multiple nodes of the computer system and that can be accessed by a computer that has established a remote session with the distributed file system. A distributed file system can also offer data redundancy via, for example, replicating a file across multiple computing nodes of a computing cluster.

### BRIEF DESCRIPTION OF THE DRAWINGS

Numerous aspects, embodiments, objects, and advantages of the present invention will be apparent upon consideration of the following detailed description, taken in conjunction with the accompanying drawings, in which like reference characters refer to like parts throughout, and in which:

FIG. 1 illustrates a block diagram of an example computer system that can facilitate installing multiple patches during upgrades, in accordance with certain embodiments of this disclosure;

FIG. 2 illustrates another block diagram of an example computer system that can facilitate installing multiple patches during upgrades, in accordance with certain embodiments of this disclosure;

FIG. 3 illustrates a sequence of installing multiple patches during upgrades for one node of a computing cluster at a time, in accordance with certain embodiments of this disclosure;

FIG. 4 illustrates a sequence of installing multiple patches during upgrades for all nodes of a computing cluster at a time, in accordance with certain embodiments of this disclosure;

FIG. 5 illustrates a sequence of installing multiple patches during upgrades for some nodes of a computing cluster at a time, in accordance with certain embodiments of this disclosure;

FIG. 6 illustrates an example process flow that can facilitate installing multiple patches during upgrades, in accordance with certain embodiments of this disclosure;

FIG. 7 illustrates an example process flow that can facilitate determining compatibility as part of installing multiple patches during upgrades, in accordance with certain embodiments of this disclosure;

FIG. 8 illustrates another example process flow that can facilitate registering a patch as part of installing multiple patches during upgrades, in accordance with certain embodiments of this disclosure;

FIG. 9 illustrates another example process flow that can facilitate a patch reconciliation process as part of installing multiple patches during upgrades, in accordance with certain embodiments of this disclosure;

FIG. 10 illustrates an example block diagram of a computer operable to execute certain embodiments of this disclosure.

### DETAILED DESCRIPTION

### Overview

Patches to update full software upgrade images can be released frequently, and may lead to multiple patches being released at once. In such situations, where customers need to upgrade with more than a single patch, it can take additional time to complete separate sequential operations for the multiple patches across the nodes of a large computing cluster. This lengthy process can expose an unreliability of one or more nodes until subsequent patches are applied after the update process is initiated. In contrast, present techniques facilitate installing multiple patches during a single operating system upgrade process.

The present techniques permit a customer to perform an upgrade and multiple cumulative roll-up patch installations at the same time, and as a single operation. This approach can allow a customer to start one update operation that will perform an operating system update, as well as applying multiple patches. Multiple cumulative roll-up patches can be released at once that can target kernel, user space, and/or security fixes. These patches can have dependencies with one another that mean that one of the patches is to be installed before another of the patches. Furthermore, this approach can decrease a time in which one or more nodes are exposed to security vulnerabilities and/or bugs on the upgraded version.

That is, patches can generally fix security vulnerabilities and bugs. So, by expediting an approach to get the latest patch installed on a node, a time spent in a less-secure state before that patch is applied can be reduced. Put another way, this decreased time in which one or more nodes are exposed to security vulnerabilities and/or bugs on the upgraded version can be mitigated because a delay in waiting for an operating system and single patch operation to be completed before starting subsequent installations that can fix these issues can be reduced. By providing multiple patches to be installed in an already-running upgrade, there can be fewer steps to coordinate between the nodes, and therefore less time spent to coordinate steps that are now omitted.

The following steps can be taken to facilitate an approach in accordance with the present techniques. A customer can specify an upgrade image and one or more patches. In a command-line interface, a “—patch-paths” option can permit the customer to specify multiple patches when initiating an upgrade. The system can then determine if the provided patches are compatible with the provided upgrade image. In a computing cluster, this compatibility check can be performed at the cluster level. That is, this compatibility check can be performed once, at the time that the upgrade is initiated for the entire cluster, regardless of how many nodes are part of the cluster. Performing a compatibility check at the cluster level can be considered in contrast to performing an operation at a node level, where an instance of the operation can be performed for each node that is being upgraded.

If it is determined that the upgrade image and the patches are compatible, then the patches can be registered to a cluster-wide database, and can be installed on individual nodes as those nodes are upgraded. Patch compatibility can be determined based on whether the specified patches are listed as being compatible with the version of the specified upgrade image in a data store that maintains a list of compatible patches with upgrade image versions. Additionally, since multiple patches can be specified to be installed during an upgrade, a system that implements the present techniques can verify that patches are compatible (i.e., patches do not conflict with each other) by validating dependencies or overlapping of files.

That is, in some examples, patches can be determined to be compatible where they do not both modify the same file.

In some examples, patches can have an order in which they are applied, and a customer can supply the patches in the order in which he or she intends for the patches to be installed. That is, in an example where a customer utilizes a command-line interface to implement an upgrade, the customer can specify a command that contains “—patch-paths X Y” where X and Y each specify a path to a patch file, and the patch indicated by X will be installed before the patch indicated by Y. While some of the examples used herein describe two patches being applied, it can be appreciated that a similar approach can be taken to applying an arbitrary number of patches.

Previous techniques do not permit for the simultaneous application of both a main release (i.e., an upgrade image) and multiple patches to be specified at the same time. Previous techniques do not perform verification of compatibility between a list of supplied patches. Previous techniques do not perform verification of the compatibility of smaller updates to a main release (that will be upgraded to) on a computing cluster.

Previously, a customer would need to start one update operation that will perform a full system image update with one patch fix. Since only one patch fix could be supplied, any additional patches that are needed for small updates to the new operating system version would need to be performed as a subsequent process once the first update operation fully completed, delaying the customer from starting the next set of processes of installing the remaining patches. In addition to the longer total time required for the two operations, if more than one patch is required to retain proper functionality and security, there can be a risk that the updated node(s) can be running in an insecure or unreliable mode until the second process of installing the remaining patches is completed.

In an example, installing multiple patches during upgrades can be effectuated on a DELL ISILON computing cluster that serves as a distributed storage system. A command-line interface to initiate upgrades can be modified to permit specifying multiple paths, e.g., the command:
isi upgrade start /ifs/install/tar.gz—skip-optional—patch-paths ‘/ifs/patch/X /ifs/patch/Y’ where X and Y each identify a patch.

An agent, such as isi_patch_agent can be delegated to handle a request to register multiple patches.

A pkg_prepregister package can be modified to remove checks that prevent multiple patches from being registered. In some examples, such a package can add additional conflict checks to verify that the patches listed after the first patch do not conflict with the ones previously requested. Additionally, in some examples, the package can have a dependency check removed, since patches following the first patch specified could be dependent on a previously specified patch in an upgrade.

### Example Architectures

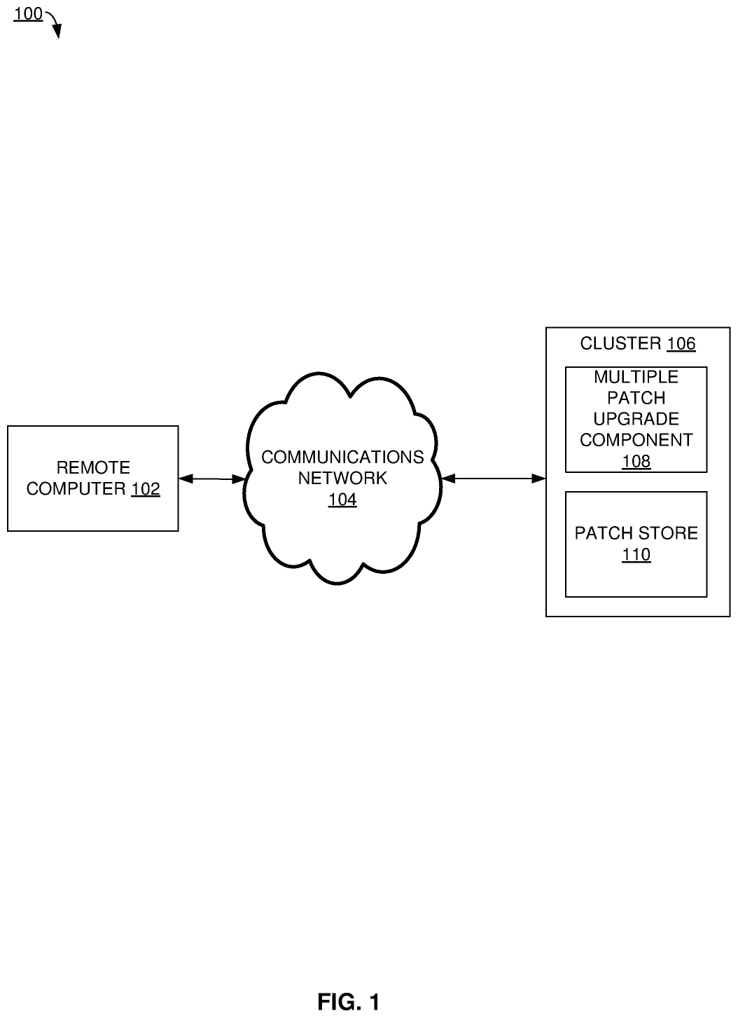

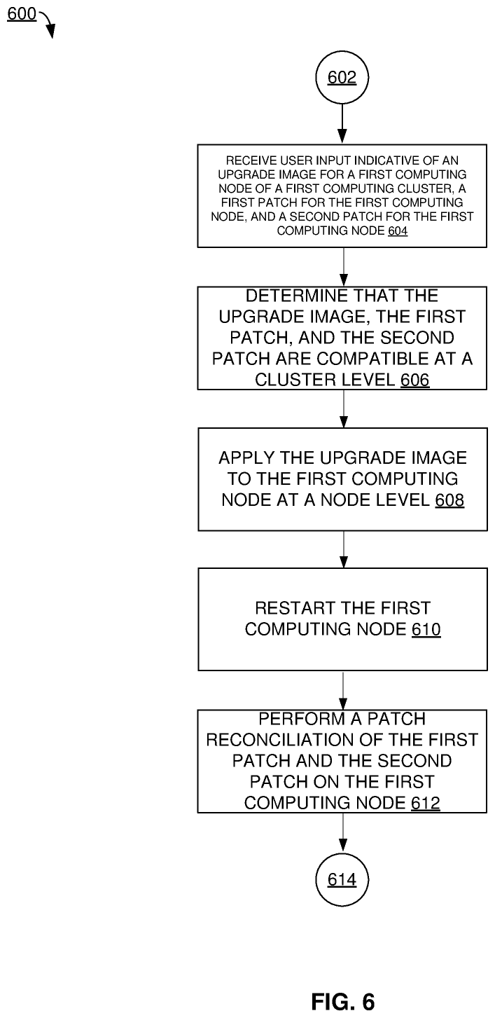

FIG. 1 illustrates a block diagram of an example computer system 100 that can facilitate installing multiple patches during upgrades, in accordance with certain embodiments of this disclosure. As depicted, computer system 100 comprises remote computer 102, communications network 104, and computer cluster 106. In turn, computer cluster 106 comprises multiple patch upgrade component 108 and patch store 110. In some examples, multiple patch upgrade component 108 can implement aspects of the process flows of FIGS. 6-9 to facilitate installing multiple patches during upgrades. Remote computer 102 and computer cluster 106 are communicatively coupled via communications network 104.

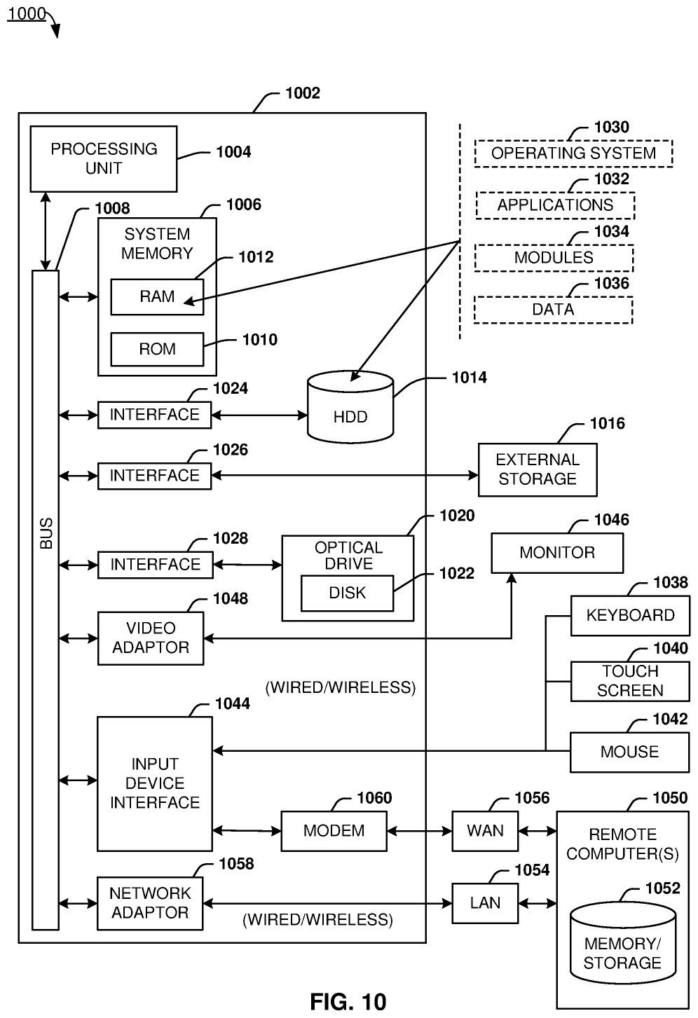

Each of remote computer 102 and computer cluster 106 can be implemented with aspects of one or more instances of computing environment 1000 of FIG. 10. Communications network 104 can comprise a computer communications network, such as the INTERNET.

Remote computer 102 can indicate to computer cluster 106 that an upgrade is to be performed on one or more nodes of computer cluster 106, and that this upgrade comprises an upgrade image and multiple patches. For example, an administrator of computer cluster 106 can utilize a command-line user interface of remote computer 102 to indicate this. In some examples, an administrator can indicate an order in which the multiple patches are to be installed. Remote computer 102 can transmit the upgrade image and the patches to computer cluster 106 via communications network 104. In other examples, the upgrade image and/or the patches can already be stored on computer cluster 106, such as in patch store 110.

Computer cluster 106 (in some examples, specifically multiple patch upgrade component 108, which can be a process that executes on computer cluster 106) can receive this information from remote computer 102. In response, computer cluster 106 can determine whether the patches and the upgrade image are compatible with each other.

In some examples, determining whether the patches and the upgrade image are compatible with each other can comprise checking each patch against a version of the upgrade image for version compatibility. The patches can be checked against each other for conflict, dependency, and file overlap requirements. In some examples where patches are specified in an order (e.g., an ordered list of patches that follows a —patch-paths option), a given patch can be checked against those patches that appear before it in the ordered list.

In some examples, determining whether the patches and the upgrade image are compatible with each other can also comprise determining whether the patches are compatible with each other. This can comprise determining the files written to, created, and/or modified by each patch and comparing them. If multiple patches do not modify the same file, then the patches can be determined to be compatible with each other. Otherwise, if multiple patches do modify the same file, then the patches can be determined to be incompatible with each other.

If compatible, computer cluster 106 can register the patches to be installed, and store the patch in patch store 110, which can be a computer memory of computer cluster 106.

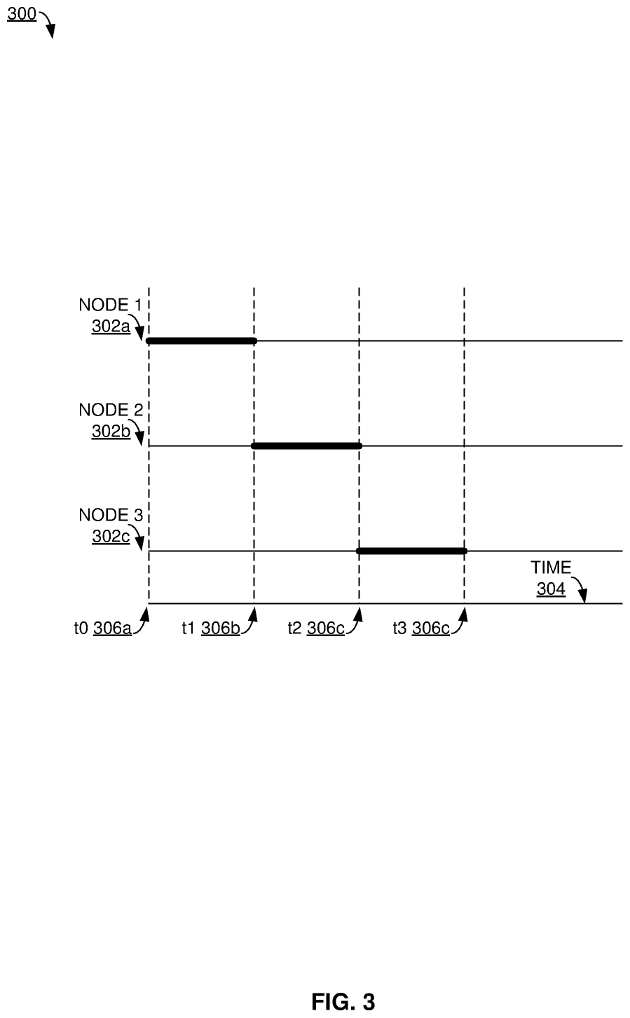

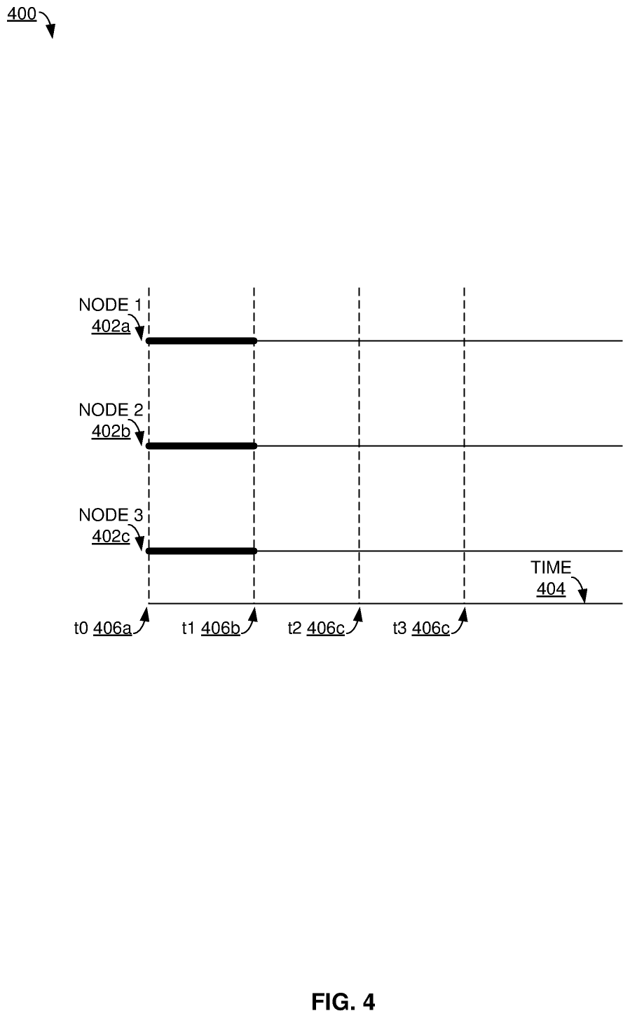

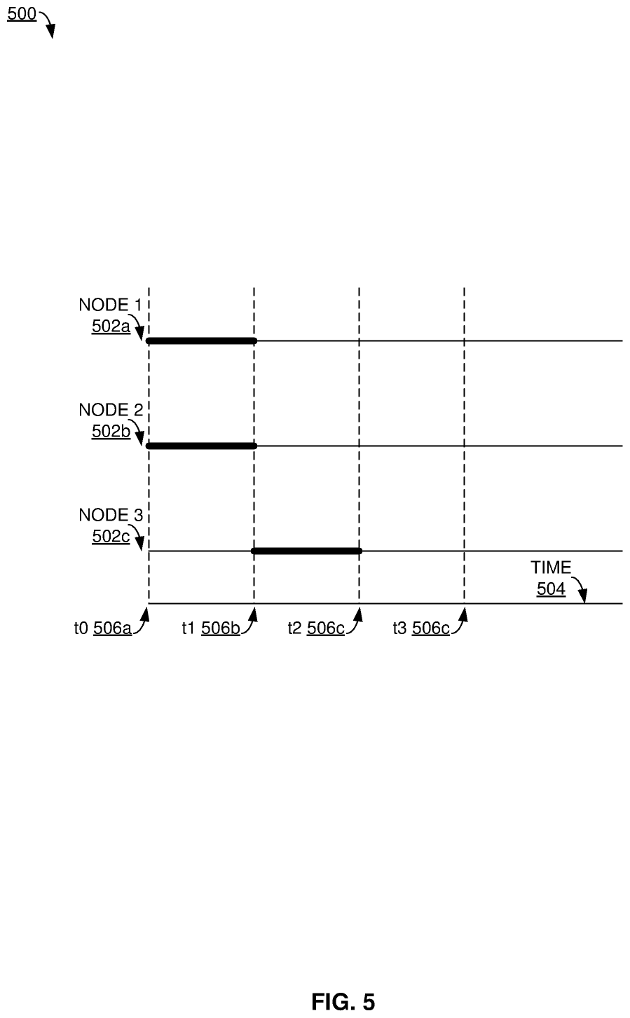

Computer cluster 106 can perform this compatibility check, and registration and storage of the patches at the cluster level—it can be performed once for computer cluster 106, independent of how many nodes are of computer cluster 106 are to be upgraded. Computer cluster 106 can then begin the upgrade process by installing the upgrade image on one or more nodes. This installation can occur one node at a time (as in FIG. 3), all nodes at once (as in FIG. 4), or some nodes at a time (as in FIG. 5).

As part of the upgrade process for a node, computer cluster 106 deploys the upgrade image to the node, and then reboots the node. After rebooting, a node of computer cluster 106 can start up on the new version of the software indicated by the upgrade image, but without the patches installed.

Once the node is running on the new version of the software indicated by the upgrade image, computer cluster 106 can run a patch reconciliation on the upgraded node. This patch reconciliation can comprise installing the multiple patches on the node in a sequential order that has been specified by an administrator. Where appropriate, further nodes can then be upgraded.

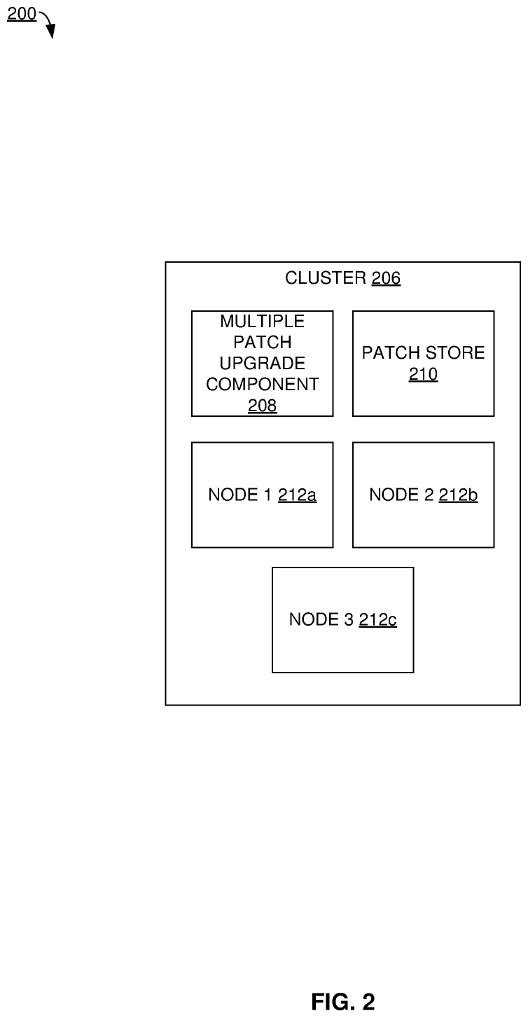

FIG. 2 illustrates another block diagram of an example computer system 200 that can facilitate installing multiple patches during upgrades, in accordance with certain embodiments of this disclosure. As depicted, computer cluster 206 comprises multiple patch upgrade component 208, patch store 210, node 1 212a, node 2 212b, and node 3 212c. It can be appreciated that there can be example computer clusters that comprise more or fewer than the three nodes (node 1 212a, node 2 212b, and node 3 212c) depicted here.

Computer cluster 206 can be implemented with aspects of one or more instances of computing environment 1000 of FIG. 10. In turn, each of node 1 212a, node 2 212b, and node 3 212c can be implemented with aspects of one or more instances of computing environment 1000 of FIG. 10.

In some examples, computer cluster 206 can be similar to computer cluster 106 of FIG. 1. In some examples, multiple patch upgrade component 208 can be similar to multiple patch upgrade component 108 of FIG. 1. In some examples, upgrade component can implement aspects of the process flows of FIGS. 6-9 to facilitate installing multiple patches during upgrades. In some examples, patch store 210 can be similar to patch store 110 of FIG. 1.

Each of node 1 212a, node 2 212b, and node 3 212c can comprise a computing node of a computing cluster. That is, each of node 1 212a, node 2 212b, and node 3 212c can comprise a computer that runs an instance of an operating system, and that is collected with other computing nodes into a computing cluster. A computing cluster can, for example, implement a distributed file system across the nodes of the computing cluster.

In some examples, a distributed file system organizes a plurality of file shares that are distributed across multiple computing nodes of a computer system. A distributed file system can offer a single namespace across the multiple nodes of the computer system and that can be accessed by a computer that has established a remote session with the distributed file system. A distributed file system can also offer data redundancy via, for example, replicating a file across multiple computing nodes of a computer system.

Computing cluster 206 can perform certain operations at the cluster level, and certain operations at the node level. For example, computing cluster 206 can perform a compatibility check for an upgrade image and multiple patches at the cluster level. Then, when it comes time to apply the upgrade image and the patches, that can be performed at the node level. That is, each node can be independently, or separately, upgraded with the upgrade image and the patches. The upgrade can be considered to be performed independently or separately because it is performed once for each node that is upgraded.

In some examples, computing cluster 206 can upgrade its nodes—here, node 1 212a, node 2 212b, and node 3 212c—at various levels of plurality or seriality. For example, node 1 212a, node 2 212b, and node 3 212c can be upgraded serially, such as described with respect to FIG. 3. In other examples, node 1 212a, node 2 212b, and node 3 212c can be upgraded simultaneously, such as described with respect to FIG. 4. In other examples, node 1 212a, node 2 212b, and node 3 212c can be upgraded such that some but not all are upgraded in parallel, such as described with respect to FIG. 5.

### Example Installation Sequences

FIG. 3 illustrates a sequence 300 of installing multiple patches during upgrades for one node of a computing cluster at a time, in accordance with certain embodiments of this disclosure. In sequence 300, three nodes are upgraded along with multiple patches one at a time, or in series.

The three nodes being upgraded are node 1 302a, node 2 302b, and node 3 302c. In some examples, each of node 1 302a, node 2 302b, and node 3 302c can be similar to node 1 212a, node 2 212b, and node 3 212c, respectively, of FIG. 2. Time 304 is depicted, with various points in time identified time t0 306a, time t1 306b, time t2 306c, and time t3 306d.

Node 1 302a is upgraded starting at time t0 306a and ending at time t1 306b. Once node 1 302a has completed upgrading (including applying multiple patches), node 2 302b is upgraded starting at time t1 306b and ending at time t2 306c. Once node 2 302b has completed upgrading (including applying multiple patches), node 3 302c is upgraded starting at time t2 306c and ending at time t3 306d. In this manner, the nodes—node 1 302a, node 2 302b, and node 3 302c—can be upgraded one at a time. In some examples, the nodes can be upgraded one at a time, but there can be a time at which no node is being upgraded. For example, there can be examples where no node is being upgraded between time t1 306b and time t2 306c.

FIG. 4 illustrates a sequence 400 of installing multiple patches during upgrades for all nodes of a computing cluster at a time, in accordance with certain embodiments of this disclosure. In some examples, each of node 1 402a, node 2 402b, and node 3 402c can be similar to node 1 212a, node 2 212b, and node 3 212c, respectively, of FIG. 2. Time 404 is depicted, with various points in time identified time t0 406a, time t1 406b, time t2 406c, and time t3 406d.

In this example, each of node 1 402a, node 2 402b, and node 4 402c are upgraded starting at time t0 406a and ending at time t1 406b. That is, they are all upgraded at the same time. It can be appreciated that it can take different amounts of time to complete an upgrade on different nodes. For example, it could be that node 2 402b is upgraded until time t2 306c. It can also be appreciated that there can be examples where not all nodes have their upgrade started at the exact same time. Rather, upgrading all nodes at the same time can be considered to be there is a time at which all nodes are undergoing some part of the upgrade process, or that an upgrade on a node can begin without regard to whether the other nodes are or are not being upgraded at that time.

FIG. 5 illustrates a sequence 500 of installing multiple patches during upgrades for some nodes of a computing cluster at a time, in accordance with certain embodiments of this disclosure. In some examples, each of node 1 502a, node 2 502b, and node 5 502c can be similar to node 1 212a, node 2 212b, and node 3 212c, respectively, of FIG. 2. Time 504 is depicted, with various points in time identified time t0 506a, time t1 506b, time t2 506c, and time t3 506d.

Node 1 502a and node 2 502b are upgraded starting at time t0 506a and ending at time t1 506b. Once either node 1 502a or node 2 502b has completed upgrading (including applying multiple patches), node 3 502c is upgraded starting at time t1 506b and ending at time t2 506c. In this manner, some of the nodes—node 1 502a, node 2 502b, and node 3 502c—can be upgraded at the same time. In this case, two nodes are permitted to be upgraded at the same time, and upgrading a third node (node 3 502c) waits until one of the earlier nodes being upgraded has completed (node 1 502a and node 2 502b).

Similar, to the example of all nodes being upgraded at the same time in FIG. 4, here the nodes do not need to have their upgrade started at the same time, and the upgrades might not end at the same time. This is one example that is shown for the sake of clarity.

### Example Process Flows

FIG. 6 illustrates an example process flow 600 that can facilitate installing multiple patches during upgrades, in accordance with certain embodiments of this disclosure. In some examples, aspects of process flow 600 can be implemented by multiple patch upgrade component 108 of FIG. 1, or multiple patch upgrade component 208 of FIG. 2. It can be appreciated that the operating procedures of process flow 600 are example operating procedures, and that there can be embodiments that implement more or fewer operating procedures than are depicted, or that implement the depicted operating procedures in a different order than as depicted.

Process flow 600 begins with 602, and moves to operation 604. Operation 604 depicts receiving user input indicative of an upgrade image for a first computing node of a first computing cluster, a first patch for the first computing node, and a second patch for the first computing node. In some examples, this user input can be received by upgrades component 108 of FIG. 1 after a user has entered the user input into a user interface of remote computer 102 and it has been transmitted to multiple patch upgrade component 108 via communications network 104.

In some examples, operation 604 comprises determining an order in which to apply the first patch and the second patch. That is, patches can be applied to the first computing node one at a time, and the order in which the patches are applied one at a time can be determined.

In some examples, the user input indicates the order in which to apply the first patch and the second patch. For example, a user can use a command-line interface to initiate the upgrade, and can identify two patches, X and Y, with “—patch-paths X Y.” In such examples, the first listed patch can be the first patch to apply, so the administrator has indicated to first apply patch X, and then apply patch Y.

In some examples, the determining the order in which to apply the first patch and the second patch is performed at the cluster level. That is, determining the order in which to apply the first patch and the second patch can be performed once for the nodes of the cluster, regardless of how many nodes are in the cluster.

In some examples, operation 604 comprises registering the first patch and the second patch to be installed for the first computing node. Registering a patch to be installed for a computing node can comprise storing the patch in a data store (such as patch store 110 of FIG. 1 or patch store 210 of FIG. 2) to be accessed later when the patch is applied to a computing node, and also storing an indication that the patch is to later be applied to a computing node (such as after an upgrade image has been applied, and the computing node has been restarted). After operation 604, process flow 600 moves to operation 606.

Operation 606 depicts determining that the upgrade image, the first patch, and the second patch are compatible at a cluster level. This can be expressed as, determining that an upgrade image, a first patch, and a second patch are compatible for a computing cluster.

In some examples, operation 606 comprises determining that the first patch and the second patch are compatible with each other. That is, two patches can be compatible with each other where they do not both modify the same file on the first computing node. This can be expressed as, determining that applying the first patch and applying the second patch omits writing to a same file.

In some examples, operation 606 comprises validating a first dependency of the first patch with a second dependency of the second patch. Some patches may depend on other patches or components being also installed. In such examples, validating a dependency for a patch can comprise determining that the other patch or component is present on the first computing node, or will be present as a result of applying another patch as part of this upgrade (e.g., if the second patch depends on the first patch, this can comprise determining that the first patch will be installed as part of this upgrade).

In some examples, determining that the upgrade image and the patch are compatible at the cluster level comprises, performing the determining that the upgrade image, the first patch, and the second patch are compatible for at least the first computing node and the second computing node of the cluster independently of performing a separate determination for each of the first computing node and the second computing node. After operation 606, process flow 600 moves to operation 608.

Operation 608 depicts applying the upgrade image to the first computing node at a node level. In some examples, operation 608 can be applied to multiple computing nodes, such as, applying the upgrade image to a first computing node of the computing cluster and a second computing node of the computing cluster.

In some examples, applying the upgrade image to the first computing node is separate from the applying the upgrade image to the second computing node. That is, the operation of applying an upgrade image to a node can be performed at a node level (as opposed to at a cluster level, like with a compatibility check), and applying the upgrade image can be performed a first time for the first node, and then performed a second time for the second node. After operation 608, process flow 600 moves to operation 610.

Operation 610 depicts restarting the first computing node. Restarting the computing node can comprise multiple patch upgrade component 208 of FIG. 2 sending an instruction to node 1 212a that node 1 212a is to restart.

In some examples, operation 610 comprises restarting the first computing node and the second computing node. That is, in examples where multiple nodes are upgraded, each node can be restarted in operation 610. After operation 610, process flow 600 moves to operation 612.

Operation 612 depicts performing a patch reconciliation of the first patch and the second patch on the first computing node. In some examples, operation 612 can be applied to multiple computing nodes, such as, performing a patch reconciliation of the first patch and the second patch on the first computing node and the second computing node.

In some examples, performing a patch reconciliation can comprise evaluating a list of installed patches (i.e., patches that are currently installed) and compare that to the list of registered patches (i.e., patches that should be, but might not be, installed) to determine a list of operations to correct for missing patches. This can be performed once per node at a time that the node reboots into the upgraded version from the upgrade image. In some examples, operation 612 comprises applying the patch to the first computing node.

In some examples, operation 612 comprises, completing the performing patch reconciliation on the first computing node before beginning the applying the upgrade image to a second computing node. That is, an upgrade can be performed one computing node at a time.

In some examples, operation 612 comprises, performing the applying the upgrade image to the first computing node concurrently with performing the applying the upgrade image to a second computing node. That is, an upgrade can be performed on all computing nodes of a cluster that are being upgraded at once.

In some examples, operation 612 comprises completing the performing patch reconciliation on the first computing node before beginning to apply the upgrade image to a third computing node of the computing cluster; and performing the beginning to apply the upgrade image to the third computing node of the computing cluster concurrently with applying the upgrade image to the second computing node. That is, an upgrade can be performed on some—but not all—of the computing nodes of a cluster that are being upgraded at once.

In some examples, operation 612 comprises applying the first patch to the first computing node, and applying the second patch to the first computing node. That is, as part of reconciliation, the patches can be applied to a computing node that is being upgraded.

In some examples, patch reconciliation comprises, evaluating one or more previously-installed patches for the first computing node; determining a missing patch based on the one or more previously-installed patches for the first computing node and a registered patch for the first computing node; and determining at least one operation to perform to apply the missing patch to the first computing node.

After operation 612, process flow 600 moves to 614, where process flow 600 ends.

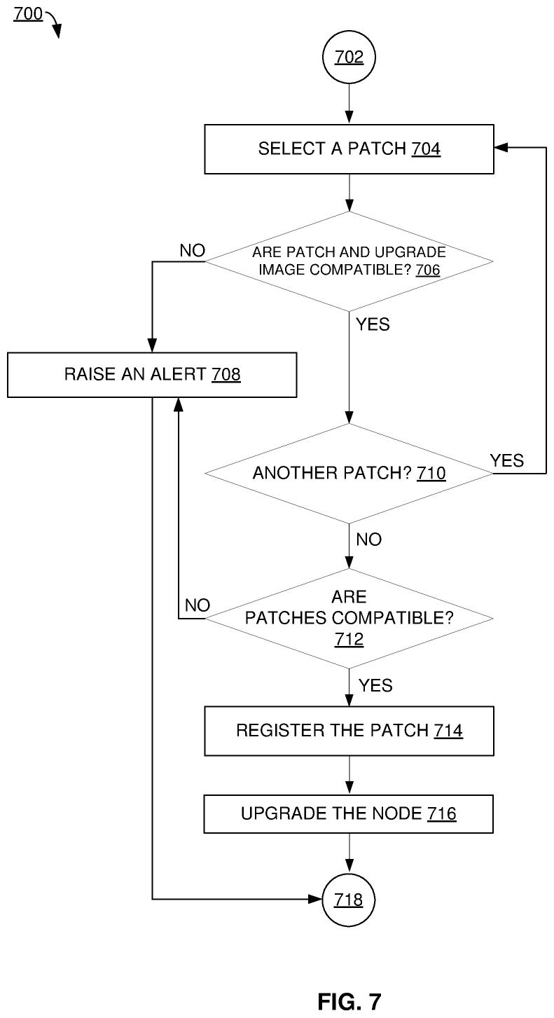

FIG. 7 illustrates an example process flow 700 that can facilitate determining compatibility as part of installing multiple patches during upgrades, in accordance with certain embodiments of this disclosure. In some examples, aspects of process flow 700 can be implemented by multiple patch upgrade component 108 of FIG. 1, or multiple patch upgrade component 208 of FIG. 2. It can be appreciated that the operating procedures of process flow 700 are example operating procedures, and that there can be embodiments that implement more or fewer operating procedures than are depicted, or that implement the depicted operating procedures in a different order than as depicted. In some examples, process flow 800 can be implemented to determine compatibility as described with respect to process flow 600 of FIG. 6.

Process flow 700 begins with 702, and then moves to operation 704. Operation 704 can also be reached from operation 710, where it is determined in operation 710 that there another patch. Operation 704 depicts selecting a patch. In some examples, an administrator has provided a list of patches to be installed. In such examples, operation 704 can comprise selecting a patch from this list that has not yet been selected in this instance of implementing process flow 700. After operation 704, process flow 700 moves to operation 706.

Operation 706 depicts determining whether a patch and an upgrade image are compatible. In some examples, this operation can be performed once per cluster at the time that an administrator indicates to upgrade one or more nodes of the cluster with an upgrade image and a patch. In some examples, operation 706 can be implemented in a similar manner as operation 606 of FIG. 6.

Where in operation 706 it is determined that a patch and an upgrade image are compatible, then process flow 700 moves to operation 710. Instead, where in operation 706 it is determined that a patch and an upgrade image are incompatible, then process flow 700 moves to operation 710.

Operation 708 is reached from operation 704 where it is determined in operation 704 that the patch and the upgrade image are incompatible, or from operation 712 where it is determined that the patches are incompatible. Operation 708 depicts raising an alert. Raising an alert can comprise presenting an indication that the upgrade image and the patch are incompatible in a user interface utilized by an administrator who began the failed update.

For example, where an administrator utilizes a user interface of remote computer 102 of FIG. 1 to begin an update, raising an alert can comprise presenting information in that user interface of remote computer 102 that the update will not be completed because the patches and the upgrade image are incompatible. After operation 708, process flow 700 moves to 718, where process flow 700 ends.

Operation 710 is reached from operation 706 where it is determined in operation 706 that the patch and the image are compatible. Operation 710 depicts determining whether there is another patch. Using the example of operation 704, operation 710 can comprise determining whether there is another patch in the list of patches supplied by the administrator that has not yet been selected in operation 704.

Where it is determined in operation 710 that there is another patch, process flow 700 returns to operation 704. In this manner, the loop from operation 704 through operation 710 can be used to traverse through and examine each patch that has been identified by an administrator for this upgrade. Instead, where it is determined in operation 710 that there is not another patch, then process flow 700 moves to operation 712.

Operation 712 is reached from operation 710, where it is determined in operation 710 that there is not another patch. Operation 712 depicts determining whether the patches are compatible. That is, operation 712 comprises determining whether the patches are compatible with each other. In some examples, determining whether the patches are compatible with each other can comprise determining which files will be modified by the patches. This can comprise analyzing a set of operations indicated to be performed in the patches, which specifies the associated files that will be modified. Where two patches will modify the same file, it can be determined that the patches are incompatible. This can be because, by both modifying the same file, each of two patches can expect that file to be in a different state, so the file will be in an incorrect state for at least one of the patches.

Where no patches modify the same file, it can then be determined that the patches are compatible. Where it is determined that the patches are compatible, process flow 700 moves to operation 714. Instead, where it is determined that the patches are incompatible, process flow 700 moves to operation 708.

Operation 714 is reached from operation 712 where it is determined in operation 712 that the patches are compatible. Operation 714 depicts registering the patches. Registering the patches can comprise multiple patch upgrade component 108 storing an indication that the patches will be applied to a node after the upgrade image is applied to the node. After operation 714, process flow 700 moves to operation 716.

Operation 716 depicts upgrading the node. In some examples, operation 716 can be implemented in a similar manner as operation 608 (applying the upgrade image to the node), operation 610 (restarting the node), and operation 612 (performing a patch reconciliation) of FIG. 6. After operation 716, process flow 700 moves to 718, where process flow 700 ends.

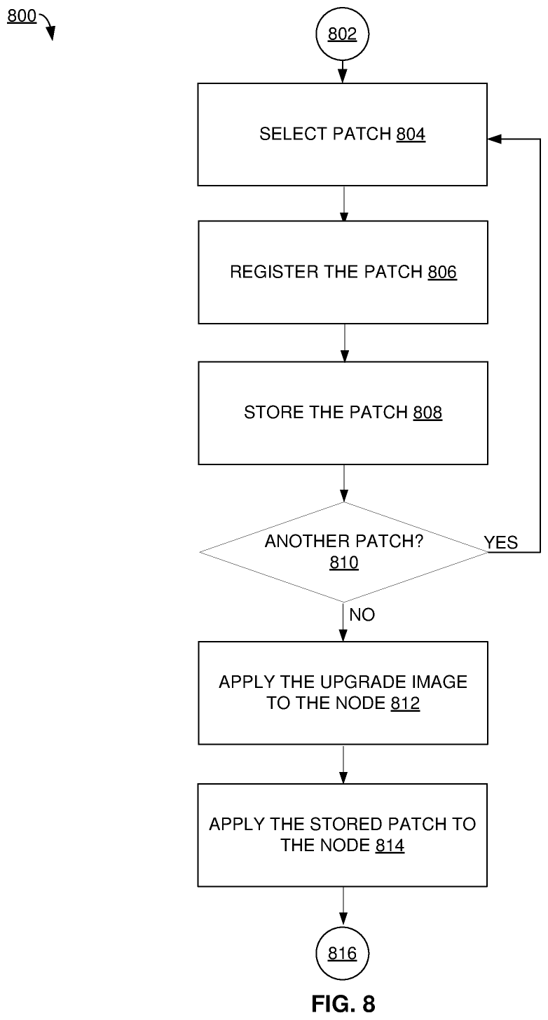

FIG. 8 illustrates another example process flow 800 that can facilitate registering a patch as part of installing multiple patches during upgrades, in accordance with certain embodiments of this disclosure. In some examples, aspects of process flow 800 can be implemented by multiple patch upgrade component 108 of FIG. 1, or multiple patch upgrade component 208 of FIG. 2. It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented to register a patch as described with respect to process flow 600 of FIG. 6.

Process flow 800 begins with 802 and moves to operation 804. Operation 804 is reached from 802, or from operation 810 where it is determined in operation 810 that there is another patch. Operation 804 depicts selecting a patch. In some examples, operation 804 can be implemented in a similar manner as operation 704 of FIG. 7. After operation 804, process flow 800 moves to operation 806.

Operation 806 depicts registering the patch. Registering the patch can comprise multiple patch upgrade component 108 storing an indication that the patch will be applied to a node after the upgrade image is applied to the node. After operation 806, process flow 800 moves to operation 808.

Operation 808 depicts storing the patch. In some examples, storing the patch comprises multiple patch upgrade component 208 of FIG. 2 storing the patch in patch store 210 of FIG. 2. After operation 808, process flow 800 moves to operation 810.

Operation 810 depicts determining whether there is another patch. In some examples, operation 810 can be implemented in a similar manner as operation 710 of FIG. 7. If it is determined in operation 810 that there is another patch, then process flow 800 returns to operation 806. Instead, if it is determined in operation 810 that there is not another patch, then process flow 800 moves to operation 812.

Operation 812 is reached from operation 810 where it is determined in operation 810 that there is not another patch. Operation 812 depicts applying the upgrade image to the node. In some examples, operation 812 can be implemented in a similar manner as operation 608 of FIG. 6. After operation 812, process flow 800 moves to operation 814.

Operation 814 depicts applying the stored patches to the node. In some examples, operation 814 can be implemented in a similar manner as operation 612 of FIG. 6. After operation 814, process flow 800 moves to 816, where process flow 800 ends.

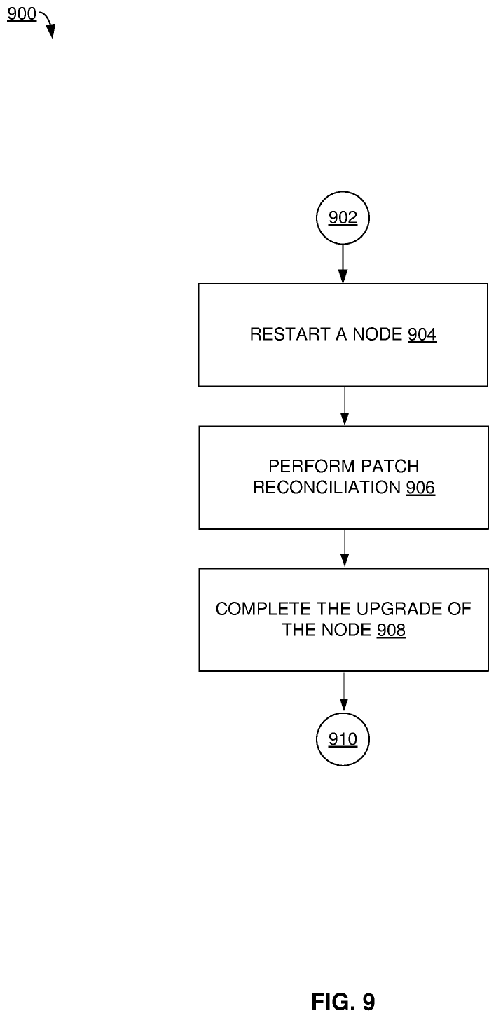

FIG. 9 illustrates another example process flow 900 that can facilitate a patch reconciliation process as part of installing multiple patches during upgrades, in accordance with certain embodiments of this disclosure. In some examples, aspects of process flow 900 can be implemented by multiple patch upgrade component 108 of FIG. 1, or multiple patch upgrade component 208 of FIG. 2. It can be appreciated that the operating procedures of process flow 900 are example operating procedures, and that there can be embodiments that implement more or fewer operating procedures than are depicted, or that implement the depicted operating procedures in a different order than as depicted. In some examples, process flow 800 can be implemented for patch reconciliation as described with respect to process flow 600 of FIG. 6.

Process flow 900 begins with 902 and moves to operation 904. Operation 904 depicts restarting a node. In some examples, restarting a node comprises multiple patch upgrade component 208 of FIG. 8 sending an instruction to node 1 212a of FIG. 2 for node 1 212a of FIG. 2 to restart, and node 1 212a restarting in response. After operation 904, process flow 900 moves to operation 906.

Operation 906 depicts performing patch reconciliation. In some examples, performing a patch reconciliation can comprise evaluating a list of installed patches (i.e., patches that are currently installed) and compare that to the list of registered patches (i.e., patches that should be, but might not be, installed) to determine a list of operations to correct for missing patches. This can be performed once per node at a time that the node reboots into the upgraded version from the upgrade image. Where multiple patches are being applied to the node, in some examples, patch reconciliation can be performed on the multiple patches together. After operation 906, process flow 900 moves to operation 908.

Operation 908 depicts completing the upgrade of the node. In some examples, completing the upgrade of the node comprises multiple patch upgrade component 208 of FIG. 2 verifying that node 1 212a of FIG. 2 has been upgraded with both the upgrade image and the patches, and that node 1 212a of FIG. 2 is operating properly. After operation 908, process flow 900 moves to 910, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented. For example, aspects of computing environment 1000 can be used to implement aspects of remote computer 102 and/or computing cluster 106 of FIG. 1, and/or prediction computing cluster 206, node 1 212a, node 2 212b, and/or node 3 212c of FIG. 2. In some examples, computing environment 1000 can implement aspects of the process flows of FIGS. 6-9 to facilitate installing multiple patches during upgrades.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” “data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system, comprising:
a processor; and
a memory that stores executable instructions that, when executed by the [[first]] processor, facilitate performance of operations, comprising:
receiving user input indicative of an upgrade image for at least one computing node of a first computing cluster that comprises multiple computing nodes, a first patch for the at least one computing node, and a second patch for the at least one computing node;
determining that the upgrade image, the first patch, and the second patch are compatible, the determining being performed once for the first computing cluster and independent of a number of nodes of the first computing cluster that are to be upgraded;
applying the upgrade image to a first computing node of the at least one computing nodes, the applying the upgrade image being performed separately for the first computing node relative to other computing nodes of the at least one computing node;
restarting the first computing node; and
performing a patch reconciliation of the first patch and the second patch on the first computing node.

2. The system of claim 1, wherein the determining that the upgrade image, the first patch, and the second patch are compatible at the cluster level comprises:
determining that the first patch and the second patch are compatible with each other.

3. The system of claim 1, wherein the determining that the upgrade image, the first patch, and the second patch are compatible at the cluster level comprises:
validating a first dependency of the first patch with a second dependency of the second patch.

4. The system of claim 1, wherein the determining that the upgrade image, the first patch, and the second patch are compatible at the cluster level comprises:
determining that applying the first patch and applying the second patch omits writing to a same file, wherein the first patch and the second patch are distinct from each other.

5. The system of claim 1, wherein the operations further comprise:
determining an order in which to apply the first patch and the second patch.

6. The system of claim 5, wherein the user input indicates the order in which to apply the first patch and the second patch.

7. The system of claim 5, wherein the determining the order in which to apply the first patch and the second patch is performed at the cluster level.

8. A method, comprising:
determining, by a system comprising a processor, that an upgrade image, a first patch, and a second patch are compatible for a computing cluster, the determining being performed for the computing cluster and independent of a number of nodes of the computing cluster that are to be upgraded;
applying, by the system, the upgrade image to a first computing node of the computing cluster and a second computing node of the computing cluster, the applying the upgrade image being performed separately for the first computing node relative to the second computing node;
restarting, by the system, the first computing node and the second computing node; and
performing, by the system, a patch reconciliation of the first patch and the second patch on the first computing node and the second computing node, the performing the patch reconciliation being performed separately for the first computing node relative to the second computing node.

9. The method of claim 8, wherein the performing the patch reconciliation of the first patch and the second patch on the first computing node comprises:
applying the first patch to the first computing node; and
applying the second patch to the first computing node.

10. The method of claim 8, further comprising:
in response to the determining, registering, by the system, the first patch and the second patch to be installed for the first computing node.

11. The method of claim 8, wherein the determining that the upgrade image, the first patch, and the second patch are compatible at the cluster level comprises:
performing the determining that the upgrade image, the first patch, and the second patch are compatible for at least the first computing node and the second computing node of the computing cluster independently of performing a separate determination for each of the first computing node and the second computing node.

12. The method of claim 8, wherein the applying the upgrade image to the first computing node is separate from the applying the upgrade image to the second computing node.

13. The method of claim 8, wherein the performing the patch reconciliation of the first patch and the second patch on the first computing node comprises:
evaluating one or more previously-installed patches for the first computing node;
determining a missing patch based on the one or more previously-installed patches for the first computing node and a registered patch for the first computing node; and
determining at least one operation to perform to apply the missing patch to the first computing node.

14. The method of claim 8, wherein the performing the patch reconciliation is performed on an arbitrary number of patches that is at least two, the arbitrary number of patches comprising the first patch and the second patch, and wherein the determining that the upgrade image, the first patch, and the second patch are compatible at the cluster level comprises:
validating a first dependency of the first patch with a second dependency of the second patch.

15. A computer-readable storage medium comprising instructions that, in response to execution, cause a system comprising a processor to perform operations, comprising:
determining that an upgrade image, a first patch, and a second patch are compatible for a computing cluster that comprises multiple nodes, the determining being performed for the computing cluster and independent of a number of nodes of the computing cluster are to be upgraded;
applying the upgrade image to a first computing node of the computing cluster, the applying the upgrade image being performed separately for the first computing node relative to other computing nodes of the computing cluster;
restarting the first computing node; and
performing a patch reconciliation of the first patch and the second patch on the first computing node.

16. The computer-readable storage medium of claim 15, wherein the operations further comprise:
completing the performing the patch reconciliation on the first computing node before beginning the applying the upgrade image to a second computing node.

17. The computer-readable storage medium of claim 15, wherein the operations further comprise:
performing the applying the upgrade image to the first computing node concurrently with performing the applying the upgrade image to a second computing node.

18. The computer-readable storage medium of claim 17, wherein the operations further comprise:
completing the performing the patch reconciliation on the first computing node before beginning to apply the upgrade image to a third computing node of the computing cluster; and
performing the beginning to apply the upgrade image to the third computing node of the computing cluster concurrently with applying the upgrade image to the second computing node.

19. The computer-readable storage medium of claim 15, wherein the determining that the upgrade image, the first patch, and the second patch are compatible at the cluster level comprises:
validating a first dependency of the first patch with a second dependency of the second patch.

20. The computer-readable storage medium of claim 15, wherein the determining that the upgrade image, the first patch, and the second patch are compatible at the cluster level comprises:
determining that applying the first patch and applying the second patch omits writing to a same file, wherein the first patch and the second patch are distinct from each other.
